(19) United States
(12) Patent Application Publication
(10) Pub. No.: US 2018/0084404 A1
(43) Pub. Date: Mar. 22, 2018

(54) SYSTEMS AND METHODS FOR ELECTRONIC PROFILE EXCHANGE THROUGH MOBILE DEVICES

(71) Applicant: Vishal Gupta, New Delhi (IN)

(72) Inventor: Vishal Gupta, New Delhi (IN)

(21) Appl. No.: 15/560,160

(22) PCT Filed: Mar. 28, 2016
(86) PCT No.: PCT/IB2016/051746

§ 371 Date: Sep. 21, 2017

Related U.S. Application Data
(60) Provisional application No. 62/139,713, filed on Mar. 28, 2015.

(51) Int. Cl. H04W 8/18; H04W 12/06; G06Q 10/10; H04M 1/2745

(52) U.S. Cl. CPC H04W 8/183; H04W 12/06; H04L 67/306; H04M 1/274516; G06Q 10/109

(57) ABSTRACT

The present disclosure relates to a method of exchanging profile information between a first user and a second user, wherein the method comprises the steps of receiving a profile exchange request from a first mobile device of a first user, wherein the request can include phone number of a second mobile device of a second user; generating a link based on the profile exchange request; transmitting the link to the second mobile device of the second user; receiving, at a server, a verification attribute from the second user through the second mobile device based on processing of the link; and enabling, at the server, exchange of the profile information between the first user and the second user based on evaluation of the verification attribute.

### FIELD OF THE DISCLOSURE

The present disclosure relates to systems and methods for providing data exchange between mobile devices. More specifically, the present disclosure relates to systems and methods for exchanging various information pertaining to profiles of users through mobile devices.

### BACKGROUND

The background description includes information that may be useful in understanding the present invention. It is not an admission that any of the information provided herein is prior art or relevant to the presently claimed invention, or that any publication specifically or implicitly referenced is prior art.

Currently, exchanging profile information is generally a manual process where both sides exchange a preprinted card. Then, both individuals end up scanning or feeding the card into their contact book. The process is time consuming, inaccurate, and very inefficient.

For centuries, businessmen and socialites have exchanged paper calling cards and business cards. These cards typically show a person's name, company, title, address or other contact information. Complex traditions, rituals and etiquette have grown around the simple exchange of business cards.

The ceremony and importance of the human element in the business card exchange remains important, but today, business contact information needs to be maintained electronically, and other opportunities for business card information exchange are described. There are programs such as Microsoft Outlook® that facilitate communication, organization, and storage of business contacts.

Unfortunately, there is not a straightforward way to electronically transfer business contact information directly into these contact managers at a first meeting. The best solution is to exchange paper business cards and later either manually enter or scan the contact information into an electronic contact manager.

Even portable electronic devices, such as the Personal Digital Assistants (PDAs), such as those made by Palm® and Sony®, are unable to easily transfer business contact information. The problem is that no standardized medium has been developed to facilitate the electronic exchange of business contact information.

There is therefore a need in the art for a system and method that allows efficient exchange of contact information between two individuals with least amount of effort.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present disclosure relates to systems and methods for providing data exchange between mobile devices. More specifically, the present disclosure relates to systems and methods for exchanging various information pertaining to profiles of users through mobile devices.

The present disclosure relates to a method of exchanging profile information between a first user and a second user, wherein the method comprises the steps of receiving a profile exchange request from a first mobile device of a first user, wherein the request can include phone number of a second mobile device of a second user; generating a link based on the profile exchange request; transmitting the link to the second mobile device of the second user; receiving, at a server, a verification attribute from the second user through the second mobile device based on processing of the link; and enabling, at the server, exchange of the profile information between the first user and the second user based on evaluation of the verification attribute.

In an aspect, in case no profile information is pre-stored for the second user, a profile can automatically be created by the computing device based on the mobile number entered by first user.

In another aspect, the second user can be provided profile information of the first user sooner the second user clicks on the URL.

In another aspect, the second user can be provided with an option to install a mobile client upon clicking of the URL, and wherein the installed mobile client can be enabled to automatically discover profile information of the second user using the unique identification code. In an aspect, the second user is automatically authenticated/verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange or authentication is disabled.

In another aspect, the unique identification code can be any or a combination of a randomly generated code, the mobile number of the second user, or a code generated based on an attribute of the second user and/or of the first user.

In yet another aspect, the first or the second user can be associated with a plurality of respective profiles from which a desired profile is selected and shared during the profile exchange.

In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MIMS, or a messaging platform.

The proposed disclosure further relates to a system of exchanging profile information between a first user and a second user, wherein system comprises a profile exchange request receive module configured to receive, at a computing device, a profile exchange request from a first mobile device of a first user, wherein the profile exchange request comprises mobile number of a second mobile device of the second user; a URL generation module configured to generate a URL operatively coupled with a unique identification code based on the profile exchange request; a URL transmission module configured to transmit the URL along with the unique identification code to the second mobile device of the second user using the mobile number to enable the second user to authenticate himself with respect to the mobile number; a verification code receive module configured to receive, at a server, a verification code automatically from the second user through the second mobile device based on processing of the URL by the second user; a profile exchange enablement module configured to enable, at the server, exchange of the profile information between the first user and the second user based on matching of the verification code received from the second user with the unique identification code, wherein the profile information of the second user is pre-stored on the server; and a second user profile updation module configured to enable the second user to update the profile information of the second user that is stored on the server.

In an aspect, in case no profile information is pre-stored for the second user, a profile can automatically be created by the server based on the mobile number entered by first user.

In another aspect, the second user can be provided profile information of the first user sooner the second user clicks on the URL.

In another aspect, the second user can be provided with an option to install a mobile client upon clicking of the URL, and wherein the installed mobile client can be enabled to automatically discover profile information of the second user using the unique identification code. In an aspect, the second user can be automatically verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange is disabled

In another aspect, the unique identification code can be any or a combination of a randomly generated code, the mobile number of the second user, or a code generated based on an attribute of the second user and/or of the first user.

In yet another aspect, the first or the second user can be associated with a plurality of respective profiles from which a desired profile is selected and shared during the profile exchange.

In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MIMS, or a messaging platform.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary representation of an overall architecture of the system and method in accordance with an embodiment of the present disclosure.

FIGS. 2A and 2B illustrate exemplary functional modules of the proposed system and method in accordance with an embodiment of the present disclosure.

FIGS. 3A, 3B and 3C illustrate operation of an exemplary embodiment of proposed system and method from the perspective of a user.

FIG. 4 illustrates operation of an exemplary embodiment of the proposed system and method using a flow chart.

FIG. 5 illustrates operation of another exemplary embodiment of the proposed system and method using a flow chart.

FIG. 6 illustrates by means of a flow chart an exemplary embodiment of the system disclosed.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms are used herein. To the extent a term used in a claim is not defined below, it should be given the broadest definition persons in the pertinent art have given that term as reflected in printed publications and issued patents at the time of filing.

The present disclosure relates to systems and methods for providing data exchange between mobile devices. More specifically, the present disclosure relates to systems and methods for exchanging various information pertaining to profiles of users through mobile devices.

In an aspect, the present disclosure relates to a method of exchanging profile information between a first user and a second user, wherein the method comprises the steps of receiving, at a computing device, a profile exchange request from a first mobile device of a first user, said profile exchange request comprising mobile number of a second mobile device of the second user; generating, at the computing device, a URL operatively coupled with a unique identification code based on the profile exchange request; transmitting, at the computing device, the URL along with the unique identification code to the second mobile device of the second user using the mobile number to enable the second user to authenticate himself with respect to the mobile number; receiving, at the computing device, a verification code automatically from the second user through the second mobile device based on processing of the URL by the second user; enabling, at the computing device, exchange of the profile information between the first user and the second user based on matching of the of the verification code received from the second user with the unique identification code, wherein the profile information of the second user is pre-stored on the computing device; and enabling the second user to update the profile information of the second user that is stored on the computing device.

In an aspect, in case no profile information is pre-stored for the second user, a profile can automatically be created by the computing device based on the mobile number entered by first user.

In another aspect, the second user can be provided profile information of the first user sooner the second user clicks on the URL.

In another aspect, the second user can be provided with an option to install a mobile client upon clicking of the URL, and wherein the installed mobile client can be enabled to automatically discover profile information of the second user using the unique identification code. In an aspect, the second user can be automatically verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange is disabled

In another aspect, the unique identification code can be any or a combination of a randomly generated code, the mobile number of the second user, or a code generated based on an attribute of the second user and/or of the first user.

In yet another aspect, the first or the second user can be associated with a plurality of respective profiles from which a desired profile is selected and shared during the profile exchange.

In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MIMS, or a messaging platform.

The proposed disclosure further relates to a system of exchanging profile information between a first user and a second user, wherein system comprises a profile exchange request receive module configured to receive, at a computing device, a profile exchange request from a first mobile device of a first user, said profile exchange request comprising mobile number of a second mobile device of the second user; a URL generation module configured to generate, at the computing device, a URL operatively coupled with a unique identification code based on the profile exchange request; a URL transmission module configured to transmit, at the computing device, the URL along with the unique identification code to the second mobile device of the second user using the mobile number to enable the second user to authenticate himself with respect to the mobile number; a verification code receive module configured to receive, at the computing device, a verification code automatically from the second user through the second mobile device based on processing of the URL by the second user; a profile exchange enablement module configured to enable, at the computing device, exchange of the profile information between the first user and the second user based on matching of the of the verification code received from the second user with the unique identification code, wherein the profile information of the second user is pre-stored on the computing device; and a second user profile updation module configured to enable the second user to update the profile information of the second user that is stored on the computing device.

In an aspect, in case no profile information is pre-stored for the second user, a profile can automatically be created by the computing device based on the mobile number entered by first user.

In another aspect, the second user can be provided profile information of the first user sooner the second user clicks on the URL.

In another aspect, the second user can be provided with an option to install a mobile client upon clicking of the URL, and wherein the installed mobile client can be enabled to automatically discover profile information of the second user using the unique identification code. In an aspect, the second user can be automatically verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange is disabled

In another aspect, the unique identification code can be any or a combination of a randomly generated code, the mobile number of the second user, or a code generated based on an attribute of the second user and/or of the first user.

In yet another aspect, the first or the second user can be associated with a plurality of respective profiles from which a desired profile is selected and shared during the profile exchange.

In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MIMS, or a messaging platform.

Embodiments herein and the various features and advantageous details thereof are explained with reference to the non-limiting embodiment in the following description. Descriptions of well-known components and processing techniques are omitted so as to not unnecessarily obscure the embodiments herein. The examples used herein are intended merely to facilitate an understanding of ways in which embodiments herein may be practiced and to further enable those of skill in the art to practice the embodiment herein. Accordingly, the description should not be construed as limiting the scope of the embodiment herein.

The description hereinafter of the specific embodiments will so fully reveal the general nature of the embodiments herein that others can, by applying current knowledge, readily modify or adapt or perform both for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Various terms as used herein are defined below. To the extent a term used in a claim is not defined below, it should be given the broadest definition persons in the pertinent art have given that term as reflected in printed publications and issued patents at the time of filing.

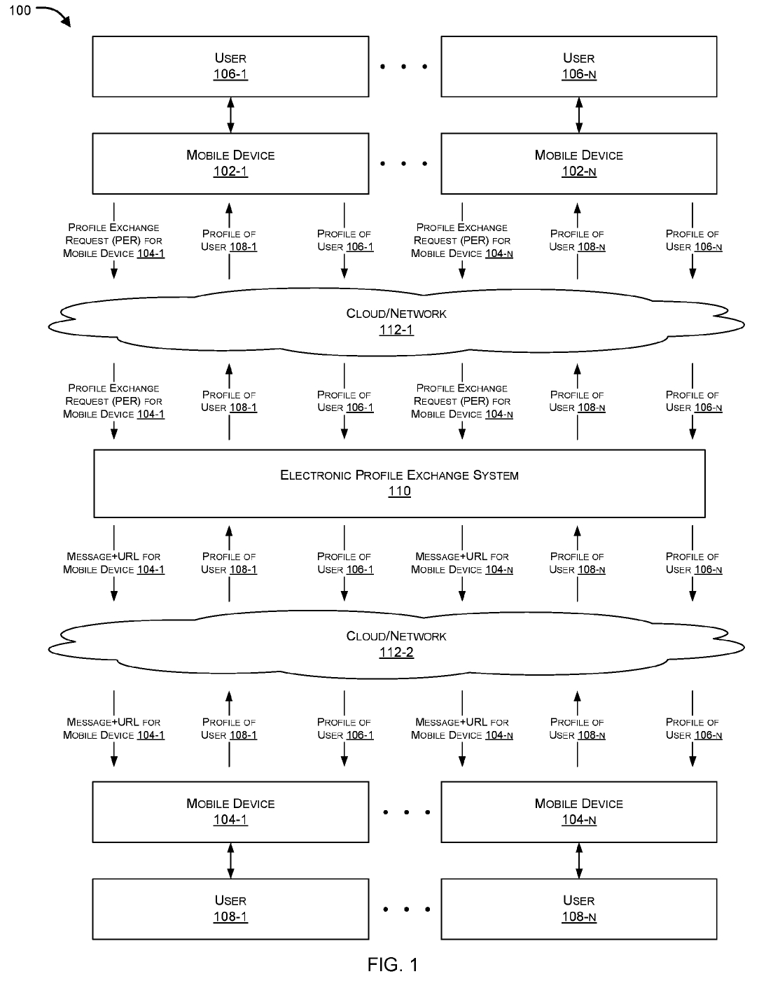

FIG. 1 illustrates an exemplary representation of an overall architecture of the system and method in accordance with an exemplary embodiment of the present disclosure.

As illustrated, relevant modules of system disclosed can be installed on a plurality of mobile devices shown as 102-1, 102-2, . . . , and 102-n (collectively referred to as mobile device(s) 102 hereinafter), each belonging to a corresponding user shown as user 106-1, 106-2, . . . , and 106-n (collectively referred to as user(s) 106 or as first user(s) 106 hereinafter) that can collectively be called as first users.

In an aspect, mobile device 102 can be selected from any portable computing device including, but not limited to, mobile phone, smart phone, tablet PC, laptop, among other like devices. In another aspect, system of the present disclosure can be configured in a client-server architecture, wherein the client side can be configured on the mobile device 102 of respective user in the form of say a downloadable application or a web-based/browser based application or any other form of implementation that is commonly used for implementing aspects of the present disclosure. Furthermore, the proposed client side and server side implementations can be configured in the form of one or more functional modules, a plurality of which can be configured to be part of a mobile application that is installed/configured on the mobile device 102, whereas the other modules can be configured on the server side. In an aspect, the client side part of system disclosed can be downloaded by a first user 106 onto his mobile device 102 after duly authenticating/registering himself with system disclosed by means well known in the art and hence not elaborated upon.

Each first user's profile can be stored in his/her corresponding mobile device 102 such that it is accessible to the proposed system being disclosed. In an exemplary embodiment, a first user's profile can be stored in the address book of his/her mobile device and can carry information such as his first name, second name, home address, work address, company, links to his social profiles, e-mail ids, among other details. In an aspect, the profile can also be referred to as contact information that can be configured in the form of say a V-card in .vcf format or any other format/file/type, all of which are completely within the scope of the present disclosure. Such profile/contact information can be configured such that it is part of a single file that can be exchanged or can be configured in such a format that the information can be retrieved by the proposed system at any desired time and shared with another user instead of actually transferring the profile/contact information file. For instance, each contact/profile information can include multiple attributes such as first/last name, phone number, email address, website URL, social profile links, among other like attributes, one or more which can be retrieved by the proposed system whenever desired and transferred in real-time with one or more other users, all possible implementations of which are completely within the scope of the present disclosure.

In another, other relevant modules of system disclosed can be configured to reside on a cloud/server/website backend. All modules of the proposed system disclosed can operatively communicate with each other as well as with users of system disclosed by using appropriate communication protocols and networks such as 112-1 and 112-2 that can include Internet.

In an exemplary aspect, a first user 106 can initiate exchange of his/her profile with that of any other person whose mobile number he/she is aware of by generating a profile exchange request (also interchangeably referred to as exchange request herein) using mobile application configured on his/her mobile device 106 by entering the mobile number of the person with whom he/she wants to exchange his/her profile. Such a person can be called a second user 108 (such as second user 108-1, 108-2, . . . , 108m). The second users are shown in FIG. 1 as user 108-1 to 108-m, each with his corresponding mobile device 104-1 to 104-m.

In an aspect, system disclosed can receive profile exchange request generated by a first user 106-1 using his/her mobile device 102-1 for a second user 108-1, and send a message and URL to the mobile device 104-1 of the second user 108-1, using mobile number of mobile device 104-1 as provided by the first user 106-1 during the process of generating a profile exchange request for profile of second user 108-1.

Upon receipt of this message and URL, second user 108-1 can click on the link, which can enable configuration of the mobile application onto his/her mobile device 104-1 as well and, using his mobile device 104-1, the second user 108-1 can authenticate/register himself on the system disclosed by providing his mobile number already provided by the first user 106-1 to the system 110 disclosed.

Once the second user 108-1 has clicked the URL (or downloaded the mobile application), and authenticated/registered himself on system disclosed, system disclosed can present to him, on his mobile device 104-1, the profile exchange request generated by first user 106-1 using his mobile device 102-1 and allow second user 108-1 to accept or reject this request.

In case the second user 108-1 accepts the exchange request, system 110 can forward his profile stored on his mobile device 104-1 to the mobile device 102-1 of the first user 106-1 for storage therein. At the same time, system 110 can forward profile of the first user 106-1 stored on his mobile device 102-1 to the mobile device 104-1 of the second user 108-1 for storage there.

In this fashion, a plurality of users can download the mobile application of system disclosed and can request profile exchange with other persons using the mobile phone number of those other persons.

In another exemplary implementation, the second user 108 can, on his/her mobile device 104, receive a SMS that is generated by the proposed system 110, wherein the SMS can include a link generated by the system 110 based on the profile exchange request generated by the first user 106. The second user 108 can then simply click on the link, which when opens up, can require the second user 108 to verify/authenticate himself/herself by entering his/her mobile number of the mobile device 104, which mobile number can be matched with the mobile number entered by the first user 106, and upon a match, profile/contact information of both the users can be retrieved from respective mobile devices 102/104 and exchanged. In an aspect, profile exchange request initiated by the first user 106 can be queued by the proposed system 110, wherein the queue can, for instance, store an identifier of the profile exchange request along with the mobile number entered by the first user 106, wherein the mobile number can then be matched with what is entered by the second user 108 and upon a match the contact information is exchanged and the request is cleared/removed from the queue.

In another preferred embodiment, during authentication/registration/signup of the second user 108 with the system disclosed after downloading the mobile application, the second user 108 can be presented by his pre-populated profile including his/her mobile number. The profile can be pre-populated using data entered by the second user 108 in his/her address book or can be collected from other data sources based upon phone number entered by the first user.

In an aspect, an exchange request can have a time out (expiry time) after passage of which it can be automatically removed from an exchange requests queue that can be maintained by system disclosed.

In another aspect, system 110 can store any profile being exchanged through it in a database that can be further used by system 110 to a verified mobile number to fetch other profile data for that verified mobile number and provide to various modules of system 110 as required.

In an aspect, system 110 disclosed can enable any of its users to download any profile that any other user has exchanged with him in the past, either on his mobile device or via the website of system disclosed after the user has properly authenticated himself. Download profile module 255 can enable such download in any suitable format such as Vcard, VCF, UDX or CSV either individually or as a list.

In another embodiment, system 110 can send a direct invite containing a unique identification code to the second user 108. For instance, system 110 can, based on contact information/profile exchange request received from first user 106, generate a link that has a unique identification code (which is also stored in the queue of the system 110 mapped with the contact information/profile exchange request received from first user 106), and send the unique identification code in the form of say an SMS or a message (say a Whatsapp™ message) to the second user 108, based on which the second user 108 can simply click on the link, upon which the unique identification code can be automatically retrieved can resent back to the system 110, which can match the code with the code that is queued, and upon a match, exchange the contact information of first user 106 with second user 108 and remove the exchange request from the queue.

In another implementation, the link having the unique identification code can be passed onto the client-side application that the second user 108 downloads on his/her mobile device 104 in order to trigger direct contact information exchange with the requesting first user 106 without the second user 108 being needed to verify/authenticate himself/herself (using his/her phone number as presented in the earlier embodiment).

The present disclosure relates to systems and methods for providing data exchange between mobile devices. More specifically, the present disclosure relates to systems and methods for exchanging various information pertaining to profiles of users through mobile devices.

In yet an aspect, the present disclosure relates to a method of exchanging profile information between a first user and a second user, wherein the method comprises the steps of receiving, at a computing device (such as a server/cloud), a profile exchange request from a first mobile device of a first user, wherein the profile exchange request can include the mobile number of a second mobile device of the second user. The method can further include the step of generating, at the computing device, a URL (such as a link or a hyperlink) that is operatively coupled with a unique identification code (also referred to as UIC hereinafter) based on the profile exchange request. The method can further include the step of transmitting, at the computing device, the URL/link along with the unique identification code to the second mobile device of the second user using the mobile number to enable the second user to authenticate himself with respect to the mobile number. The method can further include the step of receiving, at the computing device, a verification code automatically from the second user through the second mobile device based on processing of the URL by the second user; enabling, at the computing device, exchange of the profile information between the first user and the second user based on matching of the verification code received from the second user with the unique identification code, wherein the profile information of the second user is pre-stored on the computing device; and enabling the second user to update the profile information of the second user that is stored on the computing device.

In an aspect, a User 1 can send a profile exchange request by entering the mobile number of User 2 in a client-side application interface, upon receipt of which the server/computing device can generate a URL having a UIC such as http::/www.profileinformationexhcnage.com/UID=AA5635CFG, and send the URL to the second user, which simply click on the URL to enable verification/authentication thereof, which can then send the verification code (which ideally would be the same UIC AA5635CFG) back to the proposed system/server, which can match the received verification code with the previously generated UIC and to enable the profile exchange to take place.

In an aspect, in case no profile information is pre-stored for the second user, a profile can automatically be created by the computing device based on the mobile number entered by first user. Such automatic profile information can, for instance, be discovered by the system itself through various sources. The least information that can be shared can be the name and mobile number of the second user, for instance.

In another aspect, the second user can be provided profile information of the first user sooner the second user clicks on the URL. In another aspect, the second user can be provided with an option to install a mobile client upon clicking of the URL, and wherein the installed mobile client can be enabled to automatically discover profile information of the second user using the unique identification code. In an aspect, the second user can be automatically verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange can be disabled. In another aspect, the unique identification code can be any or a combination of a randomly generated code, the mobile number of the second user, or a code generated based on an attribute of the second user and/or of the first user.

In yet another aspect, the first or the second user can be associated with a plurality of respective profiles from which a desired profile is selected and shared during the profile exchange.

In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MIMS, or a messaging platform.

In a preferred embodiment, mobile verification can be part of an SMS sent by the system disclosed. In an aspect, the SMS can include a One Time Password (OTP) that can be picked up by the mobile device 104 of a second user 108 when the second user 108 is downloading the client-side application onto his/her device. This OTP can enable automatic verification of the mobile device 104 of the second user 108, and can make the profile exchange seamless with automatic phone number detection and verification in a single click. The OTP can be maintained at the server of system disclosed for a short time (live time) to prevent any fraud. Anyone using the same OTP after it is live-time has expired can be rejected by the system disclosed.

In an embodiment, system disclosed can enable a second user 108 to exchange only that information of his/her profile stored on his/her mobile device that he/her wants to with the first user. For example, the second user 108 can choose his work address, work phone number and mobile phone number to be exchanged but can allow other parts of his/her profile (contact information) such as home address and home phone number to remain private. System disclosed can enable only allowed information of the second user to be shared. In this fashion, system disclosed can have approvals added during the exchange process to enhance privacy.

In other embodiments, profile being exchanged can include date, time and location fields to provide corresponding data when exchange occurred, as well as any user generated notes at the time that can be added to profile being exchanged. In an aspect, such notes can be shared notes between the two users exchanging profiles. In another aspect, context under which the profile exchange request was initiated such as agenda for a meeting can form part of profile being exchanged.

In another embodiment, once the users have exchanged their profiles using the system disclosed, any time a user updates any of his/her profile information system disclosed can automatically send that updated information to mobile devices of all other users who have exchanged their profile in the past with the user using system disclosed. This updated information then can be stored on their mobile devices.

In another embodiment, a first user 104 can enter multiple phone numbers of the second users 108 in system disclosed, thereby initiating a profile exchange request with multiple other users simultaneously.

In another embodiment, a first user 104 can have an option to automatically initiate or authorize other connections on other social networks when a second user 108 accepts his/her exchange request. For example, if both the first user 104 and the second user 108 have a Facebook™ profile at the time of profile exchange, the first user 104 can get a “friends” request on his Facebook™ profile from the second user 108.

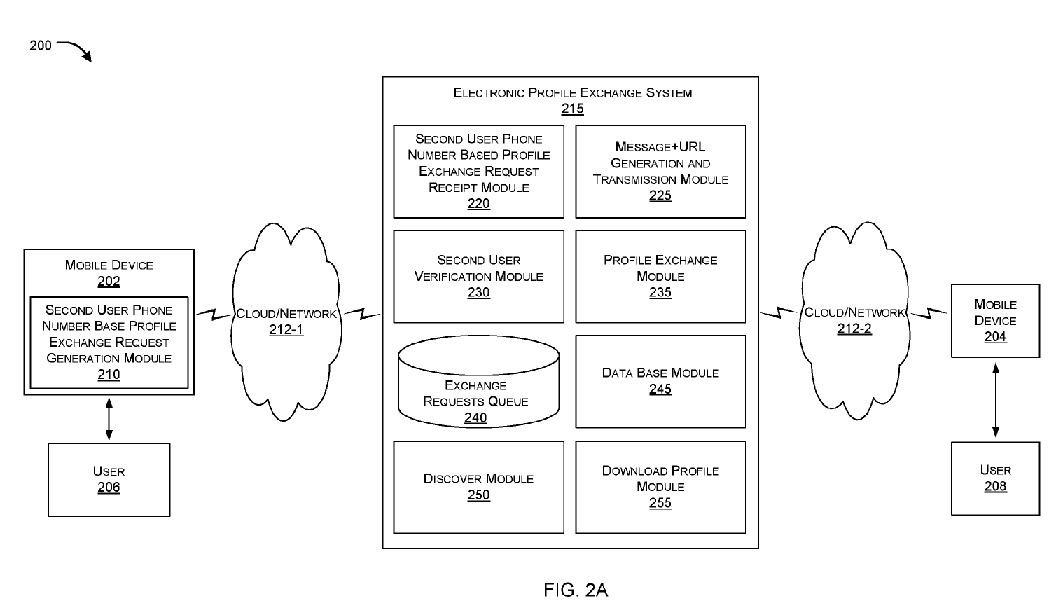

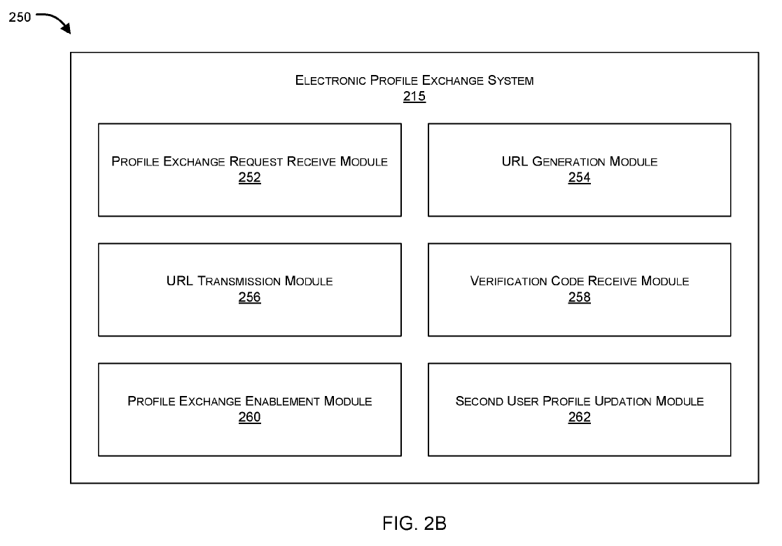

FIG. 2A illustrates exemplary functional modules of the proposed system and method in accordance with an exemplary embodiment of the present disclosure.

As illustrated, overall architecture of the proposed disclosure can include an electronic profile exchange system 215 having or being operatively coupled with a second user phone number based profile exchange request generation module 210, a second user phone number based profile exchange request receipt module 220, a message and URL generation and transmit module 225, a second user verification module 230, a profile exchange module 235. System 215 can further include an exchange requests queue 240, a database module 245, a discover module 250, and a download profile module 255.

In an aspect, various modules as appropriate of the system disclosed can be configured as part of a mobile application that can be installed on mobile phones. Other modules can be configured in a server that can be in the cloud or as part of a web server. The modules can communicate with each other as well as with other systems, assemblies, and/or sub-assemblies of the mobile phones using appropriate communication protocols and methods.

In an aspect, a first user desiring to initiate profile (also referred to as contact information) exchange process can do so by configuring an application that can be part of the system disclosed, wherein the application can verify phone number of the mobile device of the first user using verification methods well known in the art.

In a preferred embodiment, second user phone number based profile exchange request generation module 210 can be configured as part of a mobile application that can be provided on a mobile device 202 that is being used by first user 206. Second user phone number based profile exchange request generation module 210 can enable user 206 to enter mobile number (interchangeably referred hereinafter as phone number) of a user 208 whose contact information user 206 wants to exchange on his/her mobile device 202. Further, upon entering of mobile number of user 208, second user phone number based profile exchange request generation module 210 can generate a phone number based profile exchange request (hereinafter interchangeably called profile exchange request, or simply as exchange request) accordingly.

In an aspect, contact information of any user of a mobile device can be as entered and stored by him/her on his mobile device, and can include various information attributes provided by him/her about himself/herself, including, but not limited to, first name, second name, home address, location, company address and location, work designation, work phone number(s), residence phone number(s), e-mail(s), social media links, date of birth, wedding anniversary date etc. In an aspect, any information that can comprise a field in contact book of a smartphone such as photo, im handles etc. can be part of contact information.

Second user phone number based profile exchange request generation module 210 can be configured to send User 206's exchange request to second user phone number based profile exchange request receipt module 220. Upon receipt of such information, second user phone number based profile exchange request receipt module 220 can store the exchange request in an exchange request queue shown as exchange request queue 240. In an aspect, exchange request queue 240 can store all exchange requests being received from different users whose mobile devices are configured with mobile application of system disclosed and who are sending exchange requests to system disclosed using second user phone number based profile exchange request generation module 210.

In exemplary embodiments, exchange requests queue 240 can be based on a cloud or Internet server or any other database system.

Upon receipt of the exchange request, module 220 can pass it to message and URL generation and transmit module 225, wherein the module 225 can receive this request from the queue 240, and generate a message that it can communicate to the mobile device 204 of the user 208 with a URL. Such message can be sent via SMS, MMS or any other messaging platform having relevant verification in place.

In an embodiment, the message can give sufficient information to user 208 in order for the system to proceed further after getting his/her approval. In an exemplary embodiment the message may say “User 206 of phone number . . . requests your contact information, do you want to provide it? Please click on this URL if you wish to contact exchange else ignore this message”.

If user 208 wants to provide his profile information to user 206, he/her can click on the URL sent. In an aspect, clicking on the URL can enable the user 208 to verify himself/herself by means of entering his/her phone number, which can be sent back to the system 215 and matched against the phone numbers stored in the queue and upon a match, the contact information of both the users can be exchanged and the exchange request can be removed from the queue. In another aspect, clicking of the URL can enable user 208 to download application disclosed. After downloading the application, system disclosed can, through second user verification module 230, allow the second user 208 to authenticate and signup/register himself on system disclosed after providing his phone number. Consequent to such authentication, the exchange requests queue 240 can present to him on his mobile device various exchange requests received by the system disclosed for him and permit him to accept or reject any of such requests.

In another preferred embodiment, during authentication/registration/signup of the second user with system disclosed after downloading the mobile application, the second user can be presented by his pre-populated profile including his mobile number. The profile can be pre-populated using data entered by the second user in his address book or can be collected from other data sources based upon phone number entered by the first user.

In an aspect, exchange requests queue 240 can match the second user to his pending exchange requests using the phone number entered by the first user 206. In another aspect, this matching can also happen using an embedded identifier in the URL sent to the second user 208.

In another aspect, exchange requests may have a time out (expiry time) after passage of which they can automatically be removed from the exchange requests queue 240.

For the requests the second user 208 approves, profile exchange module 235 can pass on his/her contact (also interchangeably referred to as V-card) information to the users such as 206 who requested the same while at the same time can provide to the second user 208 the corresponding profiles of users such as 206 who have requested his/her profile information. In the exemplary embodiment elaborated in FIG. 2A, after the second user 208 has approved the profile exchange request of the first user 206, system disclosed can, using profile exchange module 235, pass on profile of the second user 208 (as stored on second user 208's mobile device) to the mobile device of the first User 206 and cause it to be stored in mobile device of the first user 206 for his future use. At the same time, system disclosed can, using profile exchange module 235, pass on profile of the first user 206 (as stored on first user 206's mobile device 202) to the mobile device 204 of the second user 208 and cause it to be stored in mobile device of the second user 208 for his future use.

In an aspect, system 215 can store any profile being exchanged through it in database module 245. Such data can be used by discovery module 250. In an exemplary embodiment, discovery module 250 can use a verified mobile number to fetch other profile data for that verified mobile number and provide it to other modules of system disclosed as required.

In an aspect, download profile module 255 can enable any user of the system to download any profiles any other user has exchanged with him in the past, either on his/her mobile device or via the website of system disclosed after the user has properly authenticated himself. Download profile module 255 can enable such download in any suitable format such as VCF, UDX or CSV either individually or as a list.

In another embodiment, system disclosed may not have an exchange requests queue. Instead, it can be replaced with a code that can be sent to the second user 208 as an invite. The invite can then be passed on to the application that the second user downloads on his mobile device and can trigger directly profile exchange with the first user 206, without the second user needing to authenticate himself on the system disclosed.

In another embodiment, system 215 can send a direct invite containing a unique identification code to the second user 208. For instance, system 215 can, based on contact information/profile exchange request received from first user 206, generate a link that has a unique identification code (which is also stored in the queue of the system 215 mapped with the contact information/profile exchange request received from first user 206), and send the unique identification code in the form of say an SMS or a message (say a Whatsapp™ message) to the second user 208, based on which the second user 208 can simply click on the link, upon which the unique identification code can be automatically retrieved can resent back to the system 215, which can match the code with the code that is queued, and upon a match, exchange the contact information of first user 206 with second user 208 and remove the exchange request from the queue.

In another implementation, the link having the unique identification code can be passed onto the client-side application that the second user 208 downloads on his/her mobile device 2204 in order to trigger direct contact information exchange with the requesting first user 206 without the second user 208 being needed to verify/authenticate himself/herself (using his/her phone number as presented in the earlier embodiment).

In a preferred embodiment, mobile verification can be part of SMS sent by system disclosed. In this, SMS can contain a One Time Password (OTP) that can be picked up by the mobile device 204 of the second user 208 when the user is downloading the mobile application on his device. This OTP can enable automatic verification of the mobile device 204 of the second user 208, and can make the profile exchange seamless with automatic phone number detection and verification in a single click. The OTP can be maintained at the server of system disclosed for a short time (live time) to prevent any fraud. Anyone using the same OTP after it's live time has expired can be rejected by system disclosed.

This embodiment can be useful when user 208 is not initially part of the application and server system that helps exchange the contact information. This can encourage user 208 to download mobile application of system disclosed to exchange his profile as well as invite other new users thus providing virality and onboarding for the system.

In an embodiment, profile exchange module 235 can enable the second user 208 to exchange only that information of his profile stored on his mobile device that he/she wants to with the first user 206. For example, the second user 208 can choose his work address, work phone number and mobile phone number to be exchanged but can allow other parts of his profile such as home address and home phone number to remain private. Profile exchange module 235 can enable only allowed information of the second user 208 to be shared. In this fashion, system disclosed can have approvals added during the exchange process to enhance privacy.

In other embodiments profile being exchanged can include date, time and location fields to provide corresponding data when exchange occurred, as well as any user generated notes at the time that can be added to profile being exchanged. In an aspect such notes can be shared notes between the two users exchanging profiles. In another aspect, context under which the profile exchange request was initiated such as agenda for a meeting can form part of profile being exchanged.

In another embodiment, once users have exchanged their profiles using system disclosed, any time a user updates any of his/her profile information, system disclosed can automatically send that updated information to mobile devices of all other users who have exchanged their profile in the past with the user, using system disclosed. This updated information then can be stored on their mobile devices.

In another embodiment, a user can enter multiple phone numbers at one time using second user phone number based profile exchange request generation module 210 of system disclosed, thereby initiating a profile exchange request with multiple other users simultaneously.

In another embodiment, the first user 206 can have an option to automatically initiate or authorize other connections on other social networks when the second user 208 accepts his exchange request. For example, if both the first user 206 and the second user 208 have a Facebook™ profile, at the time of profile exchange the first user 206 can get a “friends” request on his Facebook™ profile from the second user.

As elaborated above, essentially system 215 disclosed requires sending an executable code to another device and creating a loop back trigger embedded in the system to cause the users to exchange contact information seamlessly. The system can be implemented using many software languages, database systems or server architectures. The preferred embodiment requires both the mobile devices to have an Internet connection to complete the loop.

FIG. 2B illustrates another exemplary set of functional modules of the proposed system 215 in accordance with an embodiment of the present disclosure. The proposed disclosure further relates to a system 215 of exchanging profile information between a first user and a second user, wherein system 215 can include a profile exchange request receive module 252 configured to receive, at a computing device, a profile exchange request from a first mobile device of a first user, said profile exchange request having the mobile number of a second mobile device of the second user.

System 215 can further include a URL generation module 254 configured to generate, at the computing device, a URL operatively coupled with a unique identification code based on the profile exchange request. System 215 can further include a URL transmission module 256 configured to transmit, at the computing device, the URL along with the unique identification code to the second mobile device of the second user using the mobile number to enable the second user to authenticate himself with respect to the mobile number. System 215 can further include a verification code receive module 258 configured to receive, at the computing device, a verification code automatically from the second user through the second mobile device based on processing of the URL by the second user. System 215 can further include a profile exchange enablement module 260 configured to enable, at the computing device, exchange of the profile information between the first user and the second user based on matching of the of the verification code received from the second user with the unique identification code, wherein the profile information of the second user is pre-stored on the computing device. System 215 can further include a second user profile updation module 262 configured to enable the second user to update the profile information of the second user that is stored on the computing device.

In an aspect, in case no profile information is pre-stored for the second user, a profile can automatically be created by the computing device based on the mobile number entered by first user. In another aspect, the second user can be provided profile information of the first user sooner the second user clicks on the URL. In yet another aspect, the second user can be provided with an option to install a mobile client upon clicking of the URL, wherein the installed mobile client can be enabled to automatically discover profile information of the second user using the unique identification code. In an aspect, the second user can be automatically verified as user of the mobile number on the mobile client. In another aspect, the mobile number can further be used to retrieve and enhance the second user's profile information from the contacts database of the second mobile device.

In another aspect, the URL can be associated with a time-to-live, upon expiry of which, the profile exchange is disabled

In another aspect, the unique identification code can be any or a combination of a randomly generated code, the mobile number of the second user, or a code generated based on an attribute of the second user and/or of the first user. In yet another aspect, the first or the second user can be associated with a plurality of respective profiles from which a desired profile is selected and shared during the profile exchange. In another aspect, upon clicking of the URL, the second user can be given an option to approve or reject the profile exchange.

In another aspect, the profile exchange request received from the first user can be queued along with the mobile number entered by the first user, wherein upon match of the verification code received from the second user with the unique identification code, exchange of the profile information between the first user and the second user is enabled and the profile exchange request is removed from the queue.

In yet another aspect, the URL can be transmitted to the second mobile device of the second user through any or a combination of SMS, MMS, or a messaging platform.

It would appreciated that although the proposed functional modules have been explained with respect to the system being configured in a single device such as server, any of these modules can be distributed across one or more computing devices and the same functions could be performed. For instance, few of the modules can also be configured at the mobile device of the first and/or the second user, and hence all possible combinations are well within the scope of the present disclosure. For instance, the SMS having the URL can also be directly generated and transmitted from the first user's mobile device having the client-side application of the proposed system to the mobile device of the second user. In another instance, a copy of such a URL can also be then or at any other configured time sent to the server (backend) using various database synchronization techniques.

In an aspect, the proposed system includes a web interface that is configured to process/facilitate requests from the second user upon clicking of the URL by the second user. The web interface can for instance enable the second user to download the profile information of the first information (for instance in the format of vcard or a .vcf file), along with also enabling the second user to accept or reject the profile exchange request from the first user. Alternatively, web server of the present system can further enable, upon clicking of the URL by the second user, an option of downloading/installation of the mobile/client-side application/version by the second user through say a play-store or an application store while embedding the UIC.

In an aspect, one would appreciate that the proposed system does not require client-side application to be configured on both the mobile devices, wherein the application can only be configured on the first user's device and need not be configured/installed on the second user's device at all. This enables very easy and efficient exchange of profile information by not mandating the second user to have a client side application configured/downloaded on his/her mobile device.

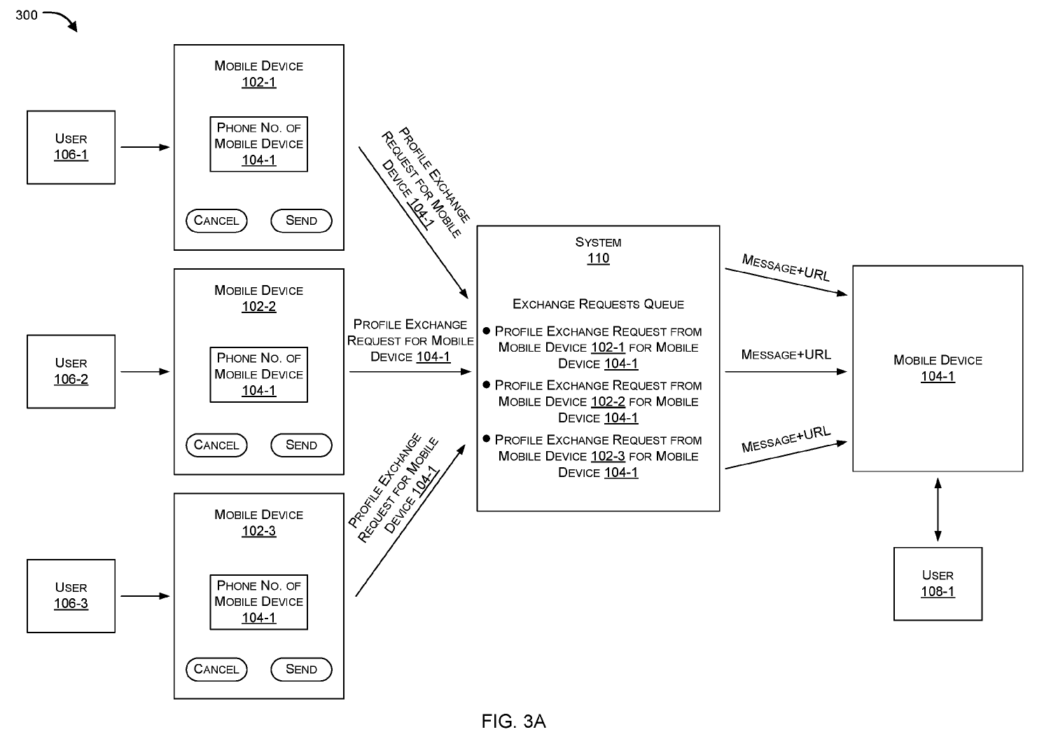

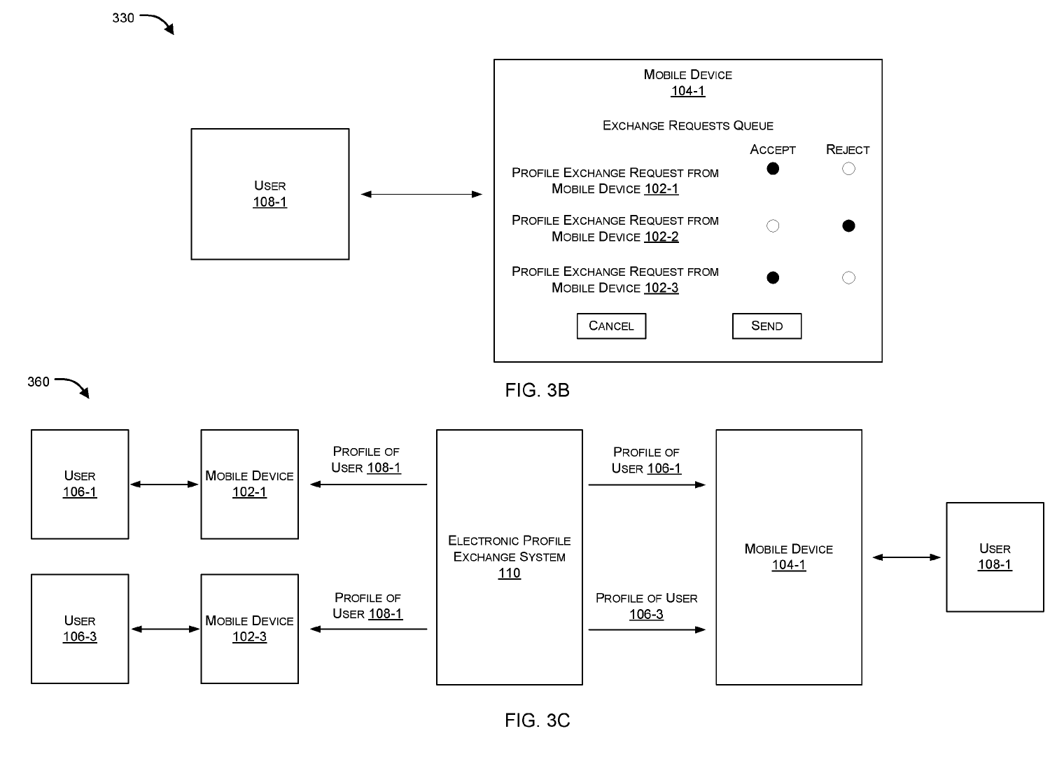

FIGS. 3A, 3B and 3C illustrate operation of an exemplary embodiment of proposed system and method from the perspective of a user. As can be seen, three users 106-1, 106-2, and 106-3 can initiate a contact information/profile exchange request through their respective mobile devices 102-1, 102-2, and 102-3 by entering the phone number of the second user 108-1 whose profile they wish to receive and exchange with their respective profile. Such phone number of the second user 108-1 can be entered at the client side of the proposed system, say either through a downloadable application or a web-based interface or any other configurable means. The profile exchange requests for user 108-1 can be received by the proposed system 110, which can queue all these requests, and then generate respective URL/links (shown as Message+URL) for each profile exchange request. Therefore mobile device 104-1 of user 108-1 can receive three links, say by means of an SMS, message, MMS, or any other like means. In case user 108-1 has also signed up with the proposed system 110, interface of the client side of the application can also show three pending requests for the user 108-1.

With respect to FIG. 3B, when the second user 108-1, on his/her mobile device 104-1, clicks the link(s), he/she can be configured to verify himself/herself by entering his/her phone number, which number can be routed back to the system 110 and verified against the queued number, and in case of a match, profiles between respective users can be exchanged. For instance, request from user 106-1 can generate URL-1, which when clicked by the user 108-1, can enable the user 108-1 to verify himself by entering his phone number, which can be sent back to the system 110 and verified against the number entered by the user 106-1, and upon a match, contact information of both users 106-1 and 108-1 can be exchanged.

In another exemplary implementation, as shown in FIG. 3B, user 108-1 can also be presented, on an interface, all the exchange requests that are pending, based on which the user 108-1 can either select Accept or Reject, and then validate/verify/authenticate himself/herself, and send his/her number back to the system 110 for matching and profile exchange. The user 108-1 can also defer the decision of accepting or denying/rejecting to another time. In another aspect, URL link sent to the user 108-1 can also be valid for a defined time only, post which any action by the user 108-1 on the link would not be processed.

In yet another aspect, it is also possible that if 3 users 106 have sent profile exchange requests to user 108, the user 108 can simply be sent a single URL/link, upon clicking and verification of which, all the pending requests for the user 108 can be processed and profile information can be exchanged and the requests can be removed from the queue. Such exchange of profile information is being shown in FIG. 3C.

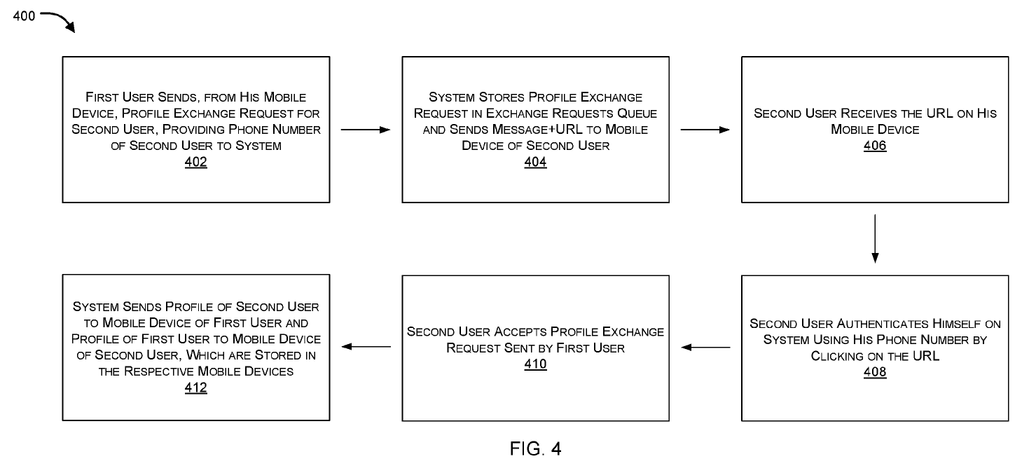

FIG. 4 illustrates operation of an exemplary embodiment of the proposed system and method using a flow chart. As shown, at block 402, first user sends, from his/her respective mobile device, a profile exchange request for a second user by providing phone number of the second user. At block 404, the system queues the request and generates a URL/link for the request to be sent to the mobile device of the second user. At block 406, the second user can either download the application by clicking on the link or can simply click on the link and open an interface where he/she can verify himself/herself (without the need to actually download the complete application). At block 408, the second user authenticates himself on the system/interface by providing an authentication attribute such as his/her phone number. At block 410, the second user accepts the profile exchange request sent by the first user, and at block 412, the system verifies the number claimed by the second user with the number entered by the first user and enables automatic exchange of profile information or any configured part thereof between the users.

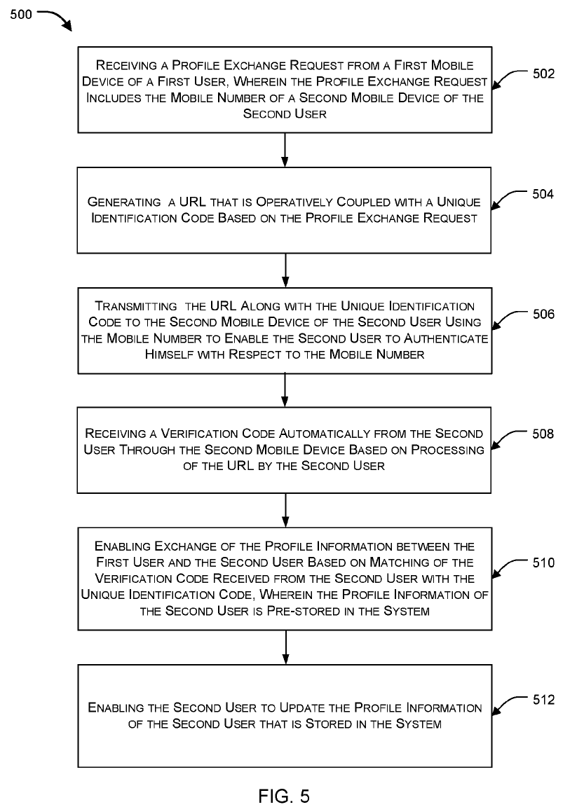

FIG. 5 illustrates operation of another exemplary embodiment of the proposed system and method using a flow chart. At 502, the method can perform the step of receiving, at a computing device (such as a server/cloud), a profile exchange request from a first mobile device of a first user, wherein the profile exchange request can include the mobile number of a second mobile device of the second user.

At 504, the method can perform the step of generating, at the computing device, a URL (such as a link or a hyperlink) that is operatively coupled with a unique identification code (also referred to as UIC hereinafter) based on the profile exchange request.

At 506, the method further includes the step of transmitting, at the computing device, the URL/link along with the unique identification code to the second mobile device of the second user using the mobile number to enable the second user to authenticate himself with respect to the mobile number.

At 508, the method can further include the step of receiving, at the computing device, a verification code automatically from the second user through the second mobile device based on processing of the URL by the second user.

At 510, the method can further include enabling, at the computing device, exchange of the profile information between the first user and the second user based on matching of the verification code received from the second user with the unique identification code, wherein the profile information of the second user is pre-stored on the computing device.

At 512, the method can include the step of enabling the second user to update the profile information of the second user that is stored on the computing device.

In another implementation, the link having the unique identification code can be passed onto the client-side application that the second user downloads on his/her mobile device in order to trigger direct contact information exchange with the requesting first user without the second user being needed to verify/authenticate himself/herself (using his/her phone number as presented in the earlier embodiment).

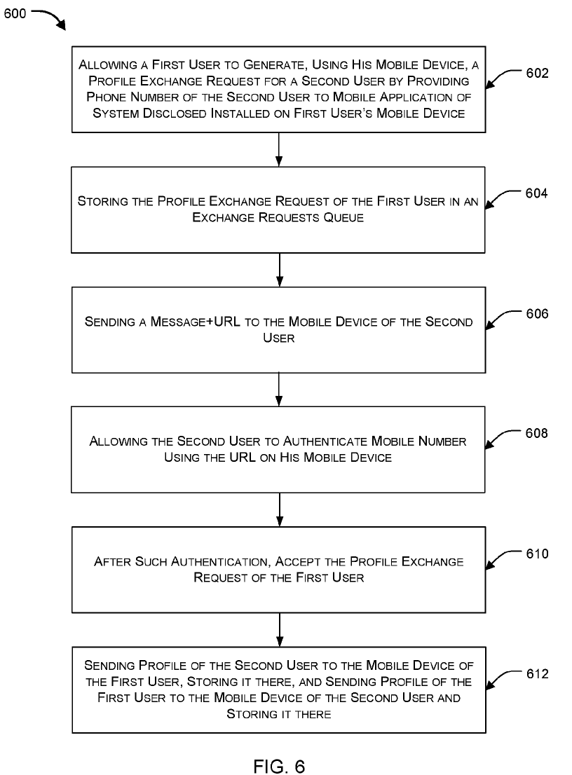

FIG. 6 illustrates by means of a flow chart an exemplary embodiment of the system disclosed. As shown, at step 602, first user sends, from his/her respective mobile device, a profile exchange request for a second user by providing phone number of the second user. At step 604, the system queues the request, at step 606, generates and sends a URL/link for the request to the mobile device of the second user. At step 608, the second user can either download the application by clicking on the link or can simply click on the link and open an interface where he/she can verify himself/herself (without the need to actually download the complete application). At step 610, the second user authenticates himself on the system/interface by providing an authentication attribute such as his/her phone number, and the second user accepts the profile exchange request sent by the first user. At step 612, the system verifies the number entered by the second user with the number entered by the first user, and enables automatic exchange of profile information or any configured part thereof between the users upon a match.

It would appreciated the proposed system and method enable light-weight implementations at the client-side applications wherein client-side is not even required at the second user's end to complete the profile exchange, making the computational resources required to complete the profile exchange minimal and efficient and cross-platform, thereby giving a strong technical effect. Furthermore, the proposed system makes the complete contact exchange process a one-click step at the second user's mobile device which maintaining privacy of the stored profile information. Furthermore, the proposed system and method enable all unsupported devices such as Blackberry, Nokia among other devices not running on Android™ or iOS™ platform to participate in the contact exchange system.

In another aspect, it is possible that a RFID chip (or a QR code or a barcode) may be embedded in the physical business cards of second users, wherein the first user can simply scan the card, and retrieve the mobile number of the second user from the RFIP chip (or the QR code or the barcode) to trigger the complete change. The business cards can therefore become re-usable. Further, the first user can also be enabled to scan the physical business card of the second user to extract the mobile number.

The proposed system also efficiently couples different mobile devices having different processors and different operating systems to collectively work together and exchange contact cards, which otherwise is not possible. The proposed central server can also seamless couple with different types/configurations of mobile devices and therefore remove all compatibility/format issues to make the contact transfer seamless. Furthermore, it is to be appreciated how a telecom network is coupled/used by the server to verify device ownerships having backward operating systems and facilitate information exchange.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions or examples, which are included to enable a person having ordinary skill in the art to make and use the disclosure when combined with information and knowledge available to the person having ordinary skill in the art.

We claim:

1. A method of exchanging profile information between a first user and a second user, said method comprising the steps of:
receiving a profile exchange request from a first mobile device of a first user, said profile exchange request comprising mobile number of a second mobile device of the second user;
generating a URL operatively coupled with a unique identification code based on the profile exchange request;
transmitting the URL along with the unique identification code to the second mobile device of the second user using the mobile number to enable the second user to authenticate himself with respect to the mobile number;
receiving, at a server, a verification code automatically from the second user through the second mobile device based on processing of the URL by the second user; and
enabling, at the server, exchange of the profile information between the first user and the second user based on matching of the of the verification code received from the second user with the unique identification code, wherein the profile information of the second user is pre-stored on the server; and
enabling the second user to update the profile information of the second user that is stored on the server.

2. The method of claim 1, wherein in case no profile information is pre-stored for the second user, a profile is automatically created by the server based on the mobile number entered by first user.

3. The method of claim 1, wherein the second user is provided profile information of the first user sooner the second user clicks on the URL.

4. The method of claim 1, wherein the second user is provided with an option to install a mobile client upon clicking of the URL, and wherein the installed mobile client is enabled to automatically discover profile information of the second user using the unique identification code.

5. The method of claim 4, wherein the second user is automatically verified as user of the mobile number on the mobile client

6. The method of claim 4, wherein the mobile number is further used to retrieve and enhance the second user's profile information from the contacts database of the second mobile device.

7. The method of claim 1, wherein URL is associated with a time-to-live, upon expiry of which, the profile exchange is disabled.

8. The method of claim 1, wherein the unique identification code is any or a combination of a randomly generated code, the mobile number of the second user, or a code generated based on an attribute of the second user and/or of the first user.

9. The method of claim 1, wherein the first or the second user are associated with a plurality of respective profiles from which a desired profile is selected and shared during the profile exchange.

10. The method of claim 1, wherein upon clicking of the URL, the second user is given an option to approve or reject the profile exchange.

11. The method of claim 1, wherein the profile exchange request received from the first user is queued along with the mobile number entered by the first user, wherein upon match of the verification code received from the second user with the unique identification code, exchange of the profile information between the first user and the second user is enabled and the profile exchange request is removed from the queue.

12. The method of claim 1, wherein the URL is transmitted to the second mobile device of the second user through any or a combination of SMS, MMS, or a messaging platform.

13. A system of exchanging profile information between a first user and a second user, said system comprising:
a profile exchange request receive module configured to receive a profile exchange request from a first mobile device of a first user, said profile exchange request comprising mobile number of a second mobile device of the second user;
a URL generation module configured to generate a URL operatively coupled with a unique identification code based on the profile exchange request;
a URL transmission module configured to transmit the URL along with the unique identification code to the second mobile device of the second user using the mobile number to enable the second user to authenticate himself with respect to the mobile number;
a verification code receive module configured to receive, at a server, a verification code automatically from the second user through the second mobile device based on processing of the URL by the second user;
a profile exchange enablement module configured to enable, at the server, exchange of the profile information between the first user and the second user based on matching of the of the verification code received from the second user with the unique identification code, wherein the profile information of the second user is pre-stored on the server; and
a second user profile updation module configured to enable the second user to update the profile information of the second user that is stored on the server.

14. The system of claim 13, wherein in case no profile information is pre-stored for the second user, a profile is automatically created by the server based on the mobile number entered by first user.

15. The system of claim 13, wherein the second user is provided profile information of the first user sooner the second user clicks on the URL.

16. The system of claim 13, wherein the second user is provided with an option to install a mobile client upon clicking of the URL, and wherein the installed mobile client is enabled to automatically discover profile information of the second user using the unique identification code.

17. The system of claim 13, wherein the second user is automatically verified as user of the mobile number on the mobile client.

18. The system of claim 13, wherein URL is associated with a time-to-live, upon expiry of which, the profile exchange is disabled, and wherein the URL is transmitted to the second mobile device of the second user through any or a combination of SMS, MMS, or a messaging platform.

19. The system of claim 13, wherein the unique identification code is any or a combination of a randomly generated code, the mobile number of the second user, or a code generated based on an attribute of the second user and/or of the first user.

20. The system of claim 13, wherein the profile exchange request received from the first user is queued along with the mobile number entered by the first user, wherein upon match of the verification code received from the second user with the unique identification code, exchange of the profile information between the first user and the second user is enabled and the profile exchange request is removed from the queue.
